(19) United States
(12) Patent Application Publication
(10) Pub. No.: US 2022/0001395 A1
(43) Pub. Date: Jan. 6, 2022

(54) FLOTATION PROCESS FOR TREATING COAL SLIME BY USING SALT-CONTAINING WASTE WATER

(71) Applicant: CHINA UNIVERSITY OF MINING AND TECHNOLOGY, Jiangsu (CN)

(72) Inventors: Xiahui GUI, Jiangsu (CN); Lixiang JIANG, Jiangsu (CN); Jianjun WU, Jiangsu (CN); Yaowen XING, Jiangsu (CN); Rui ZHANG, Jiangsu (CN); Yangchao XIA, Jiangsu (CN); Shihao DING, Jiangsu (CN); Fangyu GUO, Jiangsu (CN)

(21) Appl. No.: 17/044,273

(22) PCT Filed: Sep. 20, 2019
(86) PCT No.: PCT/CN2019/106921

§ 371 Date: Sep. 30, 2020

(30) Foreign Application Priority Data
Mar. 28, 2019 (CN) 201910242811.5

(51) Int. Cl. B03D 1/08; B03D 1/002; B03D 1/02

(52) U.S. Cl. CPC B03D 1/085; B03D 1/002; B03D 1/02; B03D 2201/04; B03D 2203/08; B03D 2201/007; B03D 2201/02; B03D 2203/008

(57) ABSTRACT

A flotation process for treating coal slime in which coal slime, a collecting agent and a frothing agent are fed into an ore slurry pretreater, and salt-containing waste water of coal chemical industry discharged from a coal chemical enterprise is fed as dilution water into the ore slurry pretreater and mixed together to complete mineralization; the mineralized ore slurry is subjected to a rough separation operation, the products obtained in the rough separation operation are subjected to a fine separation operation, and the ash content of the fine separation tailings is tested with an ash analyzer; the tailings are returned into the ore slurry pretreater for separation again if the ash content of the fine separation tailings is greater than 20%; otherwise the tailings are discharged as fine separation tailing products if the ash content of the fine separation tailings is smaller than 20%; the fine separation tailing products discharged through a pipeline enter into a pressure filter for dehydration, and filter cakes are discharged as a finally accepted concentrate product after the dehydration in the pressure filter.

### TECHNICAL FIELD

The present invention relates to a flotation process of coal slime, particularly to a flotation process for treating coal slime by using salt-containing waste water, which is applicable to the technical field of salt-containing waste water treatment and coal flotation and ash removal.

### BACKGROUND ART

China is a country with huge coal production and consumption. As the proportion of mechanized coal mining is increased and dense medium coal separation is developed rapidly, the coal slime in China exhibits characteristics including fine granularity, high ash content and high content of intergrowth, and it is more urgent to overcome the difficulties in coal slime separation. Coal slime separation mainly involves problems including poor recovery and poor separation adaptability, and most coal separation plants have to ensure coal slime yield at the cost of product quality. In recent years, as the situation of coal production becomes severe more and more, the requirements for large-scale and fine separation have been increased continuously. The degree of perfectness of the coal slime separation process has direct influence on the quality and yield of clean coal products and the washing water balance in the entire washing and separation process in the entire coal separation plant. Therefore, coal slime flotation separation has become one of the urgent problems to be solved in the enterprises in the industry.

In view of that situation, researchers at home and abroad have done a lot of research work, such as pretreatment before coal slime separation, including ultrasonic, grinding and electromagnetic microwave processing, etc.; and development of efficient flotation agents, which enhance the flotation separation process by replacing traditional diesel oil with new flotation agents and utilizing surfactants. However, those methods haven't solved the problems of high agent consumption and high cost in coal slime flotation separation process, and technical bottlenecks still exist in coal slime flotation separation process.

### CONTENTS OF THE INVENTION

### Technical Problem

the object of the present invention is to provide a flotation process for treating coal slime by using salt-containing waste water, which consists of simple steps, attains a good application effect, and can efficiently treat salt-containing waste water from coal chemical plants, reduce agent consumption in the flotation process, and treat coal slime with salt-containing waste water in an environment friendly manner.

### Technical Solution

in order to achieve the above object, the flotation process for treating coal slime by using salt-containing waste water provided by the present invention comprises the following steps:

feeding floating coal slime into an ore slurry pretreater from a bottom of the ore slurry pretreater through a pipeline b, and feeding a collecting agent and a frothing agent into the ore slurry pretreater through a pipeline c, so as to form mixed ore slurry;

feeding salt-containing waste water of coal chemical industry discharged from a coal chemical enterprise into an agitating vessel and agitating it to a homogeneous state at 30,000 mg/L brine concentration; feeding the salt water as dilution water with a circulating pump into the ore slurry pretreater through a pipeline a, so that the salt concentration of the mixed liquid in the ore slurry pretreater is increased as the salt-containing waste water of coal chemical industry is continuously fed into the ore slurry pretreater, thus the consumption of the agents in the flotation process can be effectively reduced by virtue of the improved salt concentration, while the inorganic salt ions and residual organic substances in the salt-containing waste water of coal chemical industry are absorbed on the surface of the floating coal slime;

driving the mixed ore slurry in the ore slurry pretreater to circulate by driving an impeller in the ore slurry pretreater to rotate, and completing preliminary mineralization with the participation of the collecting agent and the frothing agent, and feeding the preliminarily mineralized mixed ore slurry with a slurry pump through a pipeline d into a rough separation flotator for rough separation operation; discharging the tailings e in the rough separation flotator directly as roughly separated tail coal products through a tailings port at the bottom of the flotator after the rough separation operation of the mixed ore slurry, and feeding the overflow liquid separated by the rough separation flotator through a pipeline f into a sedimentation filtering centrifugal dehydrator for dehydration operation;

feeding the filtrate obtained in the dehydration operation of the overflow liquid with a slurry pump through a pipeline g into an agitating vessel, discharging the filter residue h obtained in the filtering operation as a rougher concentrate product through a pipeline, while supplementing the collecting agent and the frothing agent in quantity of 10% of consumed agents in the rough separation operation into the agitating vessel; after the filtrate is completely mineralized in the agitating vessel, feeding the completely mineralized filtrate i with a slurry pump through a pipeline into a fine separation flotation column for fine separation, so that the flotation concentrate product in the completely mineralized filtrate floats upward, flows over an overflow weir at the top of the fine separation flotation column and flows out of the fine separation flotation column through a pipeline k, while the flotation tailings in the completely mineralized filtrate settle down in the fine separation flotation column and are discharged via an underflow port through a pipeline j;

testing the ash content of the fine separation tailings flowing out through the pipeline j with an ash analyzer; returning fine separation tailings o through the coal slime feeding pipeline b into the ore slurry pretreater for separation again if the ash content of the fine separation tailings is greater than 20%; otherwise discharging these tailings p directly as fine separation tailing products if the ash content of the fine separation tailings is smaller than 20%;

feeding the flotation concentrate discharged out of the pipeline k into a pressure filter for dehydration, salt water n is formed by the filtrate produced in the dehydration process because the salt concentration of the filtrate is decreased as a result of adsorption of a part of metal salt ions in the filtrate on the mineral surface; directly transporting the salt water n as make-up water for fine separation operation to the agitating vessel of the flotation column; discharging filter cakes m formed in the dehydration process in the pressure filter as a finally accepted concentrate product from the bottom of the pressure filter;

repeating the above process, till the entire flotation process is completed.

The salt water n is also directly conveyed through a pipeline to an industrial waste water treatment plant for recycling treatment, and the impure salts produced in the waste water treatment plant through concentration and evaporation are used as make-up salts for rough separation and fine separation, depending on whether the concentrations of the feeding salt water meet corresponding criteria.

The concentration of salt water of the mixed ore slurry under the mixing conditions in the rough separation operation is controlled to be 11,700 mg/L-35,100 mg/L, and appropriate salts must be supplemented according to the actual requirement in the rough separation operation to ensure stable salt water concentration in the rough separation operation; the salt water concentration of the mixed ore slurry in the fine separation operation is controlled to be 1,170 mg/L-3,510 mg/L.

After the filtrate formed through the dehydration operation is fed with the slurry pump through the pipeline g into the agitating vessel, some salts must be supplemented into the agitating vessel according to the actual demand of production for salt water concentration adjustment while the collecting agent and the frothing agent in quantity of 10% of consumed agents in the rough separation operation are supplemented into the agitating vessel, so as to ensure stable salt water concentration required for the fine separation operation, wherein the collecting agent is diesel oil, and the frothing agent is sec-octyl alcohol.

The components of the salts are NaCl, Na₂SO₄, CaCl₂ and CaSO₄.

When the mixed ore slurry is separated in the rough separation flotator, metal salt ions are extensively dissolved in the flotation solution in the rough separation flotator after the mixed ore slurry is mineralized by the ore slurry pretreater; when an air filler valve of the rough separation flotator is opened, the metal salt ions compress the double electron layers of the froths, decrease the liquid drainage rate of the liquid phase among the froths, prevent the froths from merging with each other, and thereby increase the frothing rate of the froths in the floatation tank of the rough separation flotator and stabilize the thickness of the flotation froth layer; a scraper valve is opened for separation operation after the froth layer is stabilized.

After the filtrate is completely mineralized in the agitating vessel, the filtrate enters into the fine separation flotation column for fine separation operation; the gangue particles included among the froth channels are washed away by the flushing water/at the top of the fine separation flotation column, and finally the gangue particles are directly discharged along with the flotation tailings; the flotation concentrate floats upward, flows over the overflow weir at the top of the fine separation flotation column, and flows out of the flotation column through the pipeline k, while the flotation tailings settle down in the fine separation flotation column and are discharged via the underflow port of the fine separation flotation column through the pipeline j.

Beneficial effects: in the flotation process of the present invention, if metal salt ions are added in appropriate amount, the hydrated films around the surfaces of solid particles can be disturbed, so that the hydrated films surrounding the surfaces of the particles lose their stability or even break, thereby the probability of adhesion among particles and froths is improved; besides, metal cations can compress the double electron layer among the froths, and decrease the liquid drainage rate of the liquid phase among the froths, thereby prevent the froths from merging with each other, thus the drawbacks in the traditional coal slime flotation separation technology are overcome, the consumption of the agents is effectively reduced, and the efficiency of the agents is improved.

Utilizing metal salt ions for flotation separation of coal slime can ensure the stability of the flotation froth layer and greatly reduce the consumption of the flotation agents as well owing to the froth stabilization mechanism of the salt ions. On the sites of coal production enterprises (e.g., coal-to-oil and coal-to-gas enterprises, etc.), a large quantity of high-concentration industrial salt-containing waste water is produced in different production processes and hazardous waste salts are produced through concentration and evaporation of the salt-containing waste water. The ecological environment will be severely damaged if the waste water and waste salts are discharged directly, and it is quite difficult to treat the waste water and waste salts in the industry; if the industrial salt-containing waste water and waste salts are directly utilized as raw solution for flotation separation of coal slime, a production concept of adapting to local conditions and using local materials can be realized, and the difficulties in coal slime separation can be overcome as well. Utilizing the metal salt ions, the consumption of flotation agents can be reduced to 50% of the original consumption, the salt ion concentration of the original industrial salt-containing waste water can be decreased by 20%, thus the production cost of washing separation can be greatly reduced, the salt-containing waste water can be further utilized as a resource, and can be used in the pre-treatment stage in the water treatment workshop so as to greatly reduce the pressure of feed material treatment for the follow-up water treatment workshop;

In addition, the present invention further has the following advantages:

The flotation process for treating coal slime by using salt-containing waste water provided by the present invention effectively overcomes the difficulties in the treatment of salt-containing waste water from coal chemical enterprises, and provides a new idea of “treating waste with waste” for improving coal slime separation techniques.

The novel separation process provided by the present invention is in line with the concept of adapting to local conditions and using local materials in the production, links up the coal chemical enterprise with the coal washing and separation site, solves the problem of high production and transportation cost, and meets the environmental requirement of “changing wastes into valuables”.

The novel coal slime flotation process provided by the present invention greatly decreases the concentration of salt ions in the waste water while utilizing the salt-containing waste water from a coal chemical enterprise for treating coal slime. As a pretreatment link in a water treatment plant, the process can reduce the production pressure of follow-up water treatment and improve the production efficiency.

### DESCRIPTION OF DRAWINGS

FIG. 1 is a schematic flow chart of the separation process in the present invention;

FIG. 2 is a schematic structural diagram of the separation apparatus in the present invention.

In the figures: 1-agitating vessel; 2-circulating pump; 3-ore slurry pretreater; 4-slurry pump; 5-rough separation flotator; 6-sedimentation filtering centrifugal dehydrator; 7-slurry pump; 8-agitating vessel; 9-slurry pump; 10-fine separation flotation column; 11-pressure filter; 12-ash analyzer.

### EMBODIMETS

Hereunder the present invention will be further detailed in an embodiment with reference to the accompanying drawings:

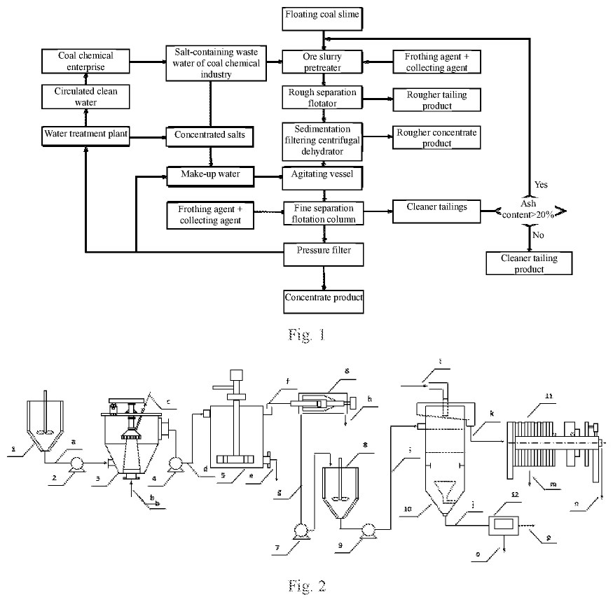

As shown in FIGS. 1 and 2, the flotation process for treating coal slime by using salt-containing waste water provided by the present invention includes the following steps:

Floating coal slime is fed into an ore slurry pretreater 3 from the bottom of the ore slurry pretreater 3 through a pipeline b, and a collecting agent and a frothing agent are fed into the ore slurry pretreater 3 through a pipeline c, so as to form mixed ore slurry;

Salt-containing waste water of coal chemical industry discharged from a coal chemical enterprise is fed into an agitating vessel 1 and agitated to a homogeneous state at 30,000 mg/L salt water concentration, wherein the components of the salt are NaCl, Na₂SO₄, CaCl₂ and CaSO₄; the salt water is fed as dilution water with a circulating pump 2 into the ore slurry pretreater 3 through a pipeline a, the salt concentration of the mixed liquid in the ore slurry pretreater 3 is increased as the salt-containing waste water of coal chemical industry is continuously fed into the ore slurry pretreater 3, thus the consumption of the agents in the flotation process can be effectively reduced by virtue of the improved salt concentration, while the inorganic salt ions and residual organic substances in the salt-containing waste water of coal chemical industry are absorbed on the surface of the floating coal slime;

The mixed ore slurry in the ore slurry pretreater 3 is driven to circulate by driving an impeller in the ore slurry pretreater 3 to rotate, and preliminary mineralization is completed with the participation of the collecting agent and the frothing agent, and the preliminarily mineralized mixed ore slurry is fed with a slurry pump 4 through a pipeline d into a rough separation flotator 5 for rough separation operation; when the mixed ore slurry is separated in the rough separation flotator 5, metal salt ions are extensively dissolved in the flotation solution in the rough separation flotator 5 after the mixed ore slurry is mineralized by the ore slurry pretreater; when an air filler valve of the rough separation flotator 5 is opened, the metal salt ions compress the double electron layers of the froths, decrease the liquid drainage rate of the liquid phase among the froths, prevent the froths from merging with each other, and thereby increase the frothing rate of the froths in the floatation tank of the rough separation flotator 5 and stabilize the thickness of the flotation froth layer; a scraper valve is opened for separation operation after the froth layer is stabilized; the coarse-particle filter residue in the rough separation flotator 5 is discharged directly as roughly separated tail coal products through a pipeline after the rough separation operation of the mixed ore slurry, and the overflow liquid separated by the rough separation flotator 5 is fed into a sedimentation filtering centrifugal dehydrator 6 for dehydration operation; the salt water concentration of the mixed ore slurry under the mixing conditions in the rough separation operation is controlled to be 11,700 mg/L-35,100 mg/L, and appropriate salts must be supplemented according to the actual requirement in the rough separation operation to ensure stable salt water concentration in the rough separation operation;

The filtrate obtained through dehydration of the overflow liquid is fed with a slurry pump 7 through a pipeline g to agitating vessel 8, while the filter residue h is discharged as a rougher concentrate product through a pipeline; at the same time, the collecting agent and the frothing agent in quantity of 10% of the consumed agents in the rough separation operation are supplemented into the agitating vessel 8, so that the filtrate is completely mineralized in the agitating vessel 8; the completely mineralized filtrate is fed with a slurry pump 9 through a pipeline into the fine separation flotation column 10 for fine separation, the salt water concentration of the mixed ore slurry is at 1,170 mg/L to 3,510 mg/L in the fine separation operation; the flotation concentrate in the completely mineralized filtrate floats upward and flows over an overflow weir at the top of the fine separation flotation column 10, and flows out of the fine separation flotation column 10 through a pipeline k, while the flotation tailings in the completely mineralized filtrate settle down in the fine separation flotation column 10 and is discharged via a underflow port through a pipeline j; after the filtrate formed through the dehydration operation is fed with the slurry pump 7 through the pipeline g into the agitating vessel 8, some salts must be supplemented into the agitating vessel 8 according to the actual demand of production for salt water concentration adjustment while the collecting agent and the frothing agent in quantity of 10% of consumed agents in the rough separation operation are supplemented into the agitating vessel 8, so as to ensure stable salt water concentration required for the fine separation operation, wherein the collecting agent is diesel oil, and the frothing agent is sec-octyl alcohol;

The ash content of the fine separation tailings flowing out through the pipeline j is tested with an ash analyzer 12; fine separation tailings o is returned through the coal slime feeding pipeline b into the ore slurry pretreater 3 for separation again if the ash content of the fine separation tailings is greater than 20%; otherwise fine separation tailings p is discharged directly as fine separation tailing products if the ash content of the fine separation tailings is smaller than 20%;

The flotation concentrate discharged out of the pipeline k is fed into a pressure filter 11 for dehydration, so that salt water n is formed by the filtrate produced in the dehydration process because the salt concentration of the filtrate is decreased as a result of adsorption of a part of metal salt ions in the filtrate on the mineral surface; the salt water n is directly transported as make-up water for fine separation operation to the agitating vessel 8; filter cakes m formed in the dehydration process in the pressure filter 11 are discharged as a finally accepted concentrate product; the salt water n is also directly conveyed through a pipeline to an industrial waste water treatment plant for recycling treatment, and the salts produced in the waste water treatment plant through concentration and evaporation are used as make-up salts for rough separation and fine separation, depending on whether the concentrations of the feeding salts meet corresponding criteria; after the filtrate is completely mineralized in the agitating vessel 8, the filtrate enters into the fine separation flotation column 10 for fine separation operation; the gangue particles included among the froth channels are washed away by the flushing water/at the top of the fine separation flotation column 10, and finally the gangue particles are directly discharged along with the flotation tailings; the flotation concentrate floats upward, flows over the overflow weir at the top of the fine separation flotation column 10, and flows out of the fine separation flotation column 10 through the pipeline k, while the flotation tailings settle down in the fine separation flotation column 10 and are discharged via the underflow port of the fine separation flotation column 10 through the pipeline j;

The above process is repeated, till the entire flotation process is completed.

1. A flotation process for treating coal slime by using salt-containing waste water, comprising the following steps:
feeding floating coal slime into an ore slurry pretreater from the bottom of the ore slurry pretreater through a first pipeline, and feeding a collecting agent and a frothing agent into the ore slurry pretreater through a second pipeline to form mixed ore slurry;
feeding salt-containing waste water of coal chemical industry discharged from a coal chemical enterprise into an agitating vessel and agitating it to a homogeneous state at 30,000 mg/L salt water concentration; feeding the salt water as dilution water with a circulating pump into the ore slurry pretreater through a third pipeline, the salt concentration of the mixed liquid in the ore slurry pretreater is increased as wherein the salt-containing waste water of coal chemical industry is continuously fed into the ore slurry pretreater, and thus the consumption of the agents in the flotation process can be effectively reduced by virtue of the improved salt concentration, while the inorganic salt ions and residual organic substances in the salt-containing waste water of coal chemical industry are absorbed on the surface of the floating coal slime;
driving the mixed ore slurry in the ore slurry pretreater to circulate by driving an impeller in the ore slurry pretreater to rotate, and completing preliminary mineralization with the participation of the collecting agent and the frothing agent, and feeding the preliminarily mineralized mixed ore slurry with a slurry pump through a fourth pipeline into a rough separation flotator for rough separation operation; discharging the rough separation tailings in the rough separation flotator directly as roughly separated tail coal products through a tailings port at the bottom of the flotator after the rough separation operation of the mixed ore slurry, and feeding the overflow liquid separated by the rough separation flotator through a fifth pipeline into a sedimentation filtering centrifugal dehydrator for dehydration operation;
feeding the filtrate obtained in the dehydration operation of the overflow liquid with a slurry pump through a sixth pipeline into an agitating vessel, discharging the filter residue obtained in the filtering operation as a rougher concentrate product through a seventh pipeline, while supplementing the collecting agent and the frothing agent in quantity of 10% of consumed agents in the rough separation operation into the agitating vessel; after the filtrate is completely mineralized in the agitating vessel, feeding the completely mineralized filtrate with a slurry pump through an eighth pipeline into a fine separation flotation column for fine separation operation, whereupon the flotation concentrate in the completely mineralized filtrate floats upward, flows over an overflow weir at the top of the fine separation flotation column and flows out of the fine separation flotation column through a ninth pipeline, while the flotation tailings in the completely mineralized filtrate settle down in the fine separation flotation column and are discharged via an underflow port through a tenth pipeline;
testing the ash content of the fine separation tailings flowing out through the tenth pipeline with an ash analyzer; returning fine separation tailings through the coal slime feeding first pipeline into the ore slurry pretreater for separation again if the ash content of the fine separation tailings is greater than 20%; otherwise discharging fine separation tailings directly as fine separation tailing products if the ash content of the fine separation tailings is smaller than 20%;
feeding the flotation concentrate discharged out of the ninth pipeline into a pressure filter for dehydration, whereupon salt water is formed by the filtrate produced in the dehydration process because the salt concentration of the filtrate is decreased as a result of adsorption of a part of metal salt ions in the filtrate on the mineral surface; directly transporting the salt water as make-up water for fine separation operation to the agitating vessel of the fine separation flotation column;
discharging filter cakes formed in the dehydration process in the pressure filter as a finally accepted concentrate product from the bottom of the pressure filter; and
repeating the above process, until the entire flotation process is completed.

2. The flotation process for treating coal slime by using salt-containing waste water according to claim 1, wherein the salt water is also directly conveyed through an eleventh pipeline to an industrial waste water treatment plant for recycling treatment, and the salts produced in the waste water treatment plant through concentration and evaporation are used as make-up salts for rough separation operation and fine separation operation, depending on whether the concentrations of the feeding salts meet corresponding criteria.

3. The flotation process for treating coal slime by using salt-containing waste water according to claim 1, wherein the salt water concentration of the mixed ore slurry under the mixing conditions in the rough separation operation is controlled to be 11,700 mg/L to 35,100 mg/L, and appropriate salts must be supplemented according to the actual requirement in the rough separation operation to ensure stable salt water concentration in the rough separation operation; and the salt water concentration of the mixed ore slurry in the fine separation operation is controlled to be 1,170 mg/L to 3,510 mg/L.

4. The flotation process for treating coal slime by using salt-containing waste water according to claim 1, wherein after the filtrate formed through the dehydration operation is fed with the slurry pump through the pipeline into the agitating vessel, some salts must be supplemented into the agitating vessel according to the actual demand of production for salt water concentration adjustment while the collecting agent and the frothing agent in quantity of 10% of consumed agents in the rough separation operation are supplemented into the agitating vessel to ensure stable salt water concentration required for the fine separation operation, wherein the collecting agent is diesel oil, and the frothing agent is sec-octyl alcohol.

5. The flotation process for treating coal slime by using salt-containing waste water according to claim 1, wherein components of the salt in the salt-containing waste water of coal chemical industry are NaCl, Na₂SO₄, CaCl₂ and CaSO₄.

6. The flotation process for treating coal slime by using salt-containing waste water according to claim 1, wherein when the mixed ore slurry is separated in the rough separation flotator, metal salt ions are extensively dissolved in the flotation solution in the rough separation flotator after the mixed ore slurry is mineralized by the ore slurry pretreater; when an air filler valve of the rough separation flotator is opened, the metal salt ions compress the double electron layers of froths, decrease the liquid drainage rate of the liquid phase among the froths, prevent the froths from merging with each other, and thereby increase the frothing rate of the froths in the floatation tank of the rough separation flotator and stabilize the thickness of the flotation froth layer; a scraper valve is opened for separation operation after the froth layer is stabilized.

7. The flotation process for treating coal slime by using salt-containing waste water according to claim 1, wherein after the filtrate is completely mineralized in the agitating vessel, the filtrate enters into the fine separation flotation column for fine separation operation; the gangue particles included among froth channels are washed away by the flushing water at the top of the fine separation flotation column, and finally the gangue particles are directly discharged along with the flotation tailings; the flotation concentrate floats upward, flows over the overflow weir at the top of the fine separation flotation column, and flows out of the fine separation flotation column through the ninth pipeline, while the flotation tailings settle down in the fine separation flotation column and are discharged via the underflow port of the fine separation flotation column through the tenth pipeline.

8. The flotation process for treating coal slime by using salt-containing waste water according to claim 3, wherein components of the salt in the salt-containing waste water of coal chemical industry are NaCl, Na₂SO₄, CaCl₂ and CaSO₄.

9. The flotation process for treating coal slime by using salt-containing waste water according to claim 4, wherein components of the salt in the salt-containing waste water of coal chemical industry are NaCl, Na₂SO₄, CaCl₂ and CaSO₄.
